(19) United States
(12) Patent Application Publication
(10) Pub. No.: US 2010/0268872 A1
(43) Pub. Date: Oct. 21, 2010

(54) DATA STORAGE SYSTEM COMPRISING MEMORY CONTROLLER AND NONVOLATILE MEMORY

(75) Inventors: Dong Jin LEE, Seoul (KR); Taek-Sung KIM, Yongin-si (KR); Kwang Ho KIM, Hwaseong-si (KR); Seong Sik HWANG, Seoul (KR); Hyuck-Sun KWON, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/762,625

(22) Filed: Apr. 19, 2010

(30) Foreign Application Priority Data
Apr. 20, 2009 (KR) 10-2009-0034223

(51) Int. Cl. G06F 12/00; G06F 12/02

(52) U.S. Cl. 711/103; 711/152; 711/E12.001; 711/E12.008; 711/E12.009

(57) ABSTRACT

A data storage system comprising a storage device comprising at least one nonvolatile memory, and a controller connected to the storage device through a channel. The memory controller sends part or all of a command, address and data for a next operation to the nonvolatile memory while the nonvolatile memory device is in a busy state. The memory controller then performs a background operation while the nonvolatile memory device remains in the busy state.

### CROSS-REFERENCE TO RELATED APPLICATIONS

This application claims priority under 35 U.S.C. §119 to Korean Patent Application No. 10-2009-0034223 filed Apr. 20, 2009, the disclosure of which is hereby incorporated by reference in its entirety.

### BACKGROUND

Embodiments of the inventive concept relate generally to a data storage system. More particularly, embodiments of the inventive concept relate to a data storage system comprising a controller and a nonvolatile memory.

Modern electronic devices commonly use large amounts of memory. For instance, devices such as personal computers, laptops, smart phones, digital video recorders, and others, often come equipped with several gigabytes or even terabytes of memory. Moreover, auxiliary memory devices, such as portable flash cards and compact flash cards, can be used to supplement the data stores of many devices.

These large amounts of memory can take a variety of forms, including various forms of nonvolatile and volatile memory. Hard disk drives (HDDs), for instance, are one common way of providing large amounts of memory due to its relatively high integration density and relatively low cost. Similarly, dynamic random access memory (DRAM) and static random access memory (SRAM) are also common due to their relatively high speed and low cost. Unfortunately, all of these types of memories have some significant drawbacks. For instance, HDDs have numerous moving parts and are relatively susceptible to defects from mechanical shock. Meanwhile, DRAMs and SRAMs are both volatile forms of memory, so they do not store data when disconnected from power.

Some increasingly common alternatives to the above types of memory are nonvolatile memories such as flash memory. Flash memories have a number of attractive properties, including relatively high integration density, decreasing cost, ability to withstand physical shock, nonvolatile data storage, and others. Because of these and other properties, flash memories have already been adopted for use in a wide variety of electronic devices, ranging from portable devices to home electronics and others.

### SUMMARY

Embodiments of the inventive concept provide a data storage system comprising a storage device and a controller.

According to one embodiment of the inventive concept, a data storage system, comprises a storage device comprising a plurality of nonvolatile memories each capable of assuming a busy state and a ready state, and a controller interfacing with the storage device via a channel and configured to transmit a part or all of a command, address and data for an operation to a selected nonvolatile memory in the storage device while the selected nonvolatile memory is in the busy state. The storage device stores the transmitted part or all of the command, address and data and the controller performs a background operation while the selected nonvolatile memory remains in the busy state.

In certain embodiments, the command is one of a program command, an erase command, and a read command.

In certain embodiments, the background operation comprises one of garbage collection, a merge operation, and a map data update or backup operation.

In certain embodiments, each of the nonvolatile memories is configured to latch the part or all of the command, the address and data transmitted from the controller.

In certain embodiments, each of the nonvolatile memories comprises a ready/busy control unit configured to generate a ready/busy control signal, a command and address register block configured to latch an address and a command received from the controller and to operate in response to the ready/busy control signal, and a program/read/erase control unit configured to control an operation based on the command and address latched in the command and address register block in response to the ready/busy control signal.

In certain embodiments, the command and address register block is configured to latch a command and an address received from the controller during a ready state or a busy state of the ready/busy control signal. The address and command received from the controller during the busy state are respectively sent to a row decoder and the program/read/erase control unit after the ready/busy control signal changes to the ready state.

In certain embodiments, each of the nonvolatile memories further comprises a page buffer block that operates under control of the program/read/erase control unit and is configured to read data from a memory cell array and to program data to the memory cell array.

In certain embodiments, the page buffer block comprises a switch configured to operate under control of the program/read/erase control unit, a page register configured to store data received through the switch during a ready state of a corresponding nonvolatile memory, and a buffer register configured to store data received through the switch during a busy state of the corresponding nonvolatile memory.

In certain embodiments, the corresponding nonvolatile memory is set to the busy state, the program/read/erase control unit controls the switch to send data stored in the buffer register to the page register. In certain embodiments, the data storage system is one of a solid state disk and a memory card. In certain embodiments, the busy state is one of a programming busy state, a read busy state and an erase busy state. In certain embodiments, at least one of the nonvolatile memories comprises a flash memory.

### BRIEF DESCRIPTION OF THE DRAWINGS

Embodiments of the inventive concept are described below with reference to the accompanying drawings. In the drawings, like reference numbers denote like features. In the drawings:

FIG. 1 is a block diagram of a data storage system according to an embodiment of the inventive concept;

FIG. 2 is a block diagram of a nonvolatile memory in the data storage device of FIG. 1 according to an embodiment of the inventive concept;

FIG. 3 is a block diagram of a page buffer in FIG. 2 according to an embodiment of the inventive concept;

FIG. 4 is a timing diagram illustrating a first operation of the data storage system of FIG. 1 according to an embodiment of the inventive concept;

FIG. 5 is a timing diagram illustrating a second operation of the data storage system of FIG. 1 according to an embodiment of the inventive concept;

FIG. 6 is a timing diagram illustrating a third operation of the data storage system of FIG. 1 according to an embodiment of the inventive concept; and

FIG. 7 is a computing system comprising the data storage system of FIG. 1 according to an embodiment of the inventive concept.

### DETAILED DESCRIPTION OF THE EMBODIMENTS

Various embodiments will be described more fully hereinafter with reference to the accompanying drawings. The inventive concept may, however, be embodied in many different forms and should not be construed as being limited to only the illustrated embodiments. Rather, these embodiments are presented as teaching examples.

In the description that follows, where an element is referred to as being “connected” or “coupled” to another element, it can be directly connected or coupled to the other element or intervening elements may be present. In contrast, where an element is referred to as being “directly connected” or “directly coupled” to another element, there are no intervening elements present. As used herein, the term “and/or” includes any and all combinations of one or more of the associated listed items.

The terminology used herein is intended to describe particular embodiments and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” where used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning consistent with their meaning in the context of the relevant art and/or the present application, and will not be interpreted in an idealized or overly formal sense unless expressly so defined herein.

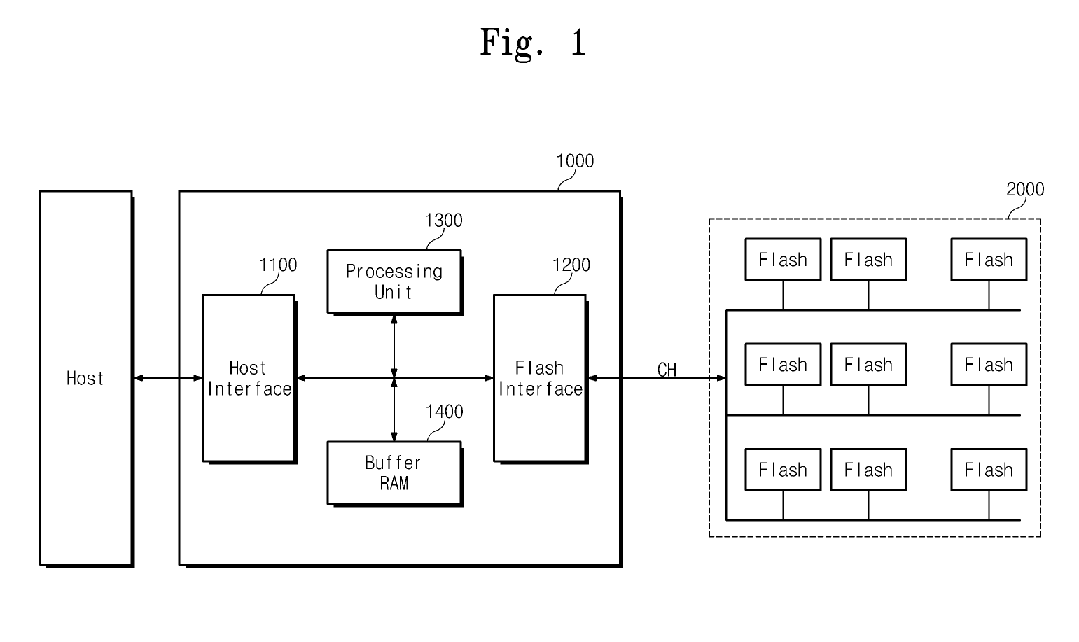

FIG. 1 is a block diagram of a data storage system according to an embodiment of the inventive concept. Referring to FIG. 1, the data storage system comprises a controller 1000 and a storage device 2000. The storage device 2000 comprises at least one nonvolatile memory device and may take the form of, e.g., a solid state disk (SSD), a portable storage device such as a memory card, or the like, with the controller 1000. In the illustrated embodiment, the at least one nonvolatile memory device takes the form of a plurality of flash memories. Alternatively, the at least one nonvolatile memory device may comprise, e.g., a charge trap flash (CTF) memory, a variable resistance memory using a variable resistance element as a memory cell, a ferroelectric memory, and the like.

Controller 1000 interfaces with an external device (e.g., a host) through one or more channels. The channels may comprise, e.g., a standardized interface such as parallel advanced technology attachment (PATA), serial advanced technology attachment (SATA), integrated drive electronics (IDE), universal serial bus (USB), small computer system interface (SCSI), enhanced small disk interface (ESDI), and/or IDE interface.

Controller 1000 comprises a host interface 1100, a flash interface 1200, a processing unit 1300, and a buffer RAM 1400. For simplicity, other elements typically included in controller 1000 are omitted. Host interface 1100 interfaces with the host, and flash interface 1200 interfaces with storage device 2000. Processing unit 1300 controls the overall operation of controller 1000. Buffer RAM 1400 temporarily stores data that is written to or read from storage device 2000.

Storage device 2000 is connected to controller 1000 through one or more channels, and each of the channels is connected with a plurality of nonvolatile memory devices. Although FIG. 1 shows a single channel CH, the data storage system may incorporate additional channels.

Each nonvolatile memory device in storage device 2000 is connected to a single channel. Each of these nonvolatile memory devices may comprise, for instance, a single-level flash memory device, a multi-level flash memory device, a One-NAND flash memory device, PRAM, MRAM, or another type of nonvolatile memory. Additionally, different types of flash memories may be connected to different channels. For instance, single-level flash memories may be connected to one channel, multi-level flash memories may be connected to another channel, and One-NAND flash memories may be connected to the other channel. Alternatively, each channel may be connected with single-level flash memories or multi-level flash memories. Each of the multi-level flash memories connected to each channel may be configured to store M-bit data in each memory cell, where M is an integer greater than or equal to 2.

Controller 1000 transfers a command, address, and data for a requested operation to a nonvolatile memory device in storage device 2000 via a channel. After receiving the transferred command, address, and data, the nonvolatile memory device transmits a ready/busy signal (R/nB) to controller 1000 to indicate whether it is in a busy state or a ready state. If controller 1000 sends a command, address, and/or data to the nonvolatile memory device while the nonvolatile memory device is in the busy state, the nonvolatile memory receives and stores the transferred command, address, and/or data into its internal registers even after controller 1000 receives the ready/busy signal indicating the busy state. In other words, even where the nonvolatile memory device connected to the channel is in the busy state, a command, address, and/or data needed to operate the next operation of the nonvolatile memory are transferred from controller 1000 to the nonvolatile memory of storage device 2000.

By transmitting information to the nonvolatile memory device even where the nonvolatile memory device is in busy state, controller 1000 avoids waiting for the nonvolatile memory device to assume the ready state, which improves the operating speed of the data storage system. Moreover, during the time where the nonvolatile memory device remains in the busy state, controller 1000 may perform other functions, including background operations, such as various flash translation layer (FTL) functions and garbage collection, merge operations, update operations of map data, backup operations storing map data into the storage device, etc. Controller 1000 may also perform external requests that do not require access to storage device 2000.

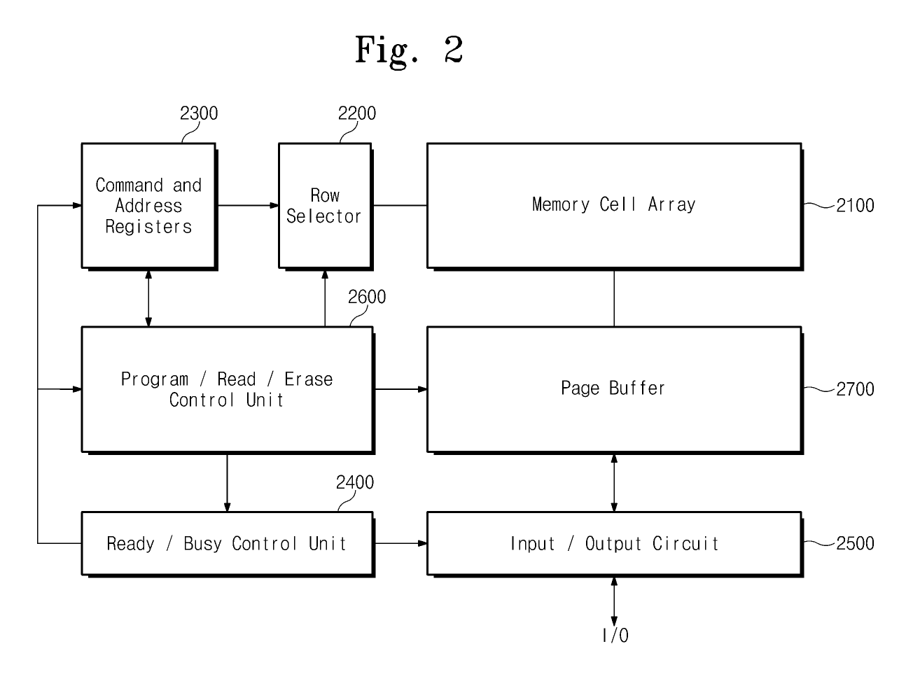

FIG. 2 is block diagram of a nonvolatile memory device in storage device 2000 according to an embodiment of the inventive concept. In the embodiment of FIG. 2, the nonvolatile memory device is a flash memory device. In alternative embodiments, however, the nonvolatile memory device may take different forms. In the explanation that follows, it will be assumed that each flash memory device of storage device 2000 has the same construction as the flash memory device shown in FIG. 2.

Referring to FIG. 2, the flash memory device comprises a memory cell array 2100, a row selector 2200, a command and address register block 2300, a ready/busy control unit 2400, an input/output circuit 2500, a program/read/erase control unit 2600, and a page buffer 2700. Memory cell array 2100 comprises a plurality of memory cells arranged in a matrix. Each memory cell stores 1-bit data or M-bit data, where M is an integer greater than or equal to 2. Memory cell array 2100 may be a three-dimensional structure or a two-dimensional structure. Row selector 2200 generates signals for selecting and driving of rows of memory cells in response to addresses received from command and address register block 2300. Command and address register block 2300 is configured to receive a command and an address in response to a ready/busy control signal generated by ready/busy control unit 2400. Although not shown in FIG. 2, command and address register block may distinguish between commands and addresses by a combination of control signals, such as /CE, /RE, /WE, CLE, and ALE. In various embodiments, these control signals may be provided to both command and address register block 2300 and program/read/erase control unit 2600.

Where the read/busy control signal indicates a flash memory device is in a ready state, command and address register block 2300 latches the address received through input/output circuit 2500, and transmits the latched address to row selector 2200. On the other hand, where the read/busy control signal indicates that the flash memory device is in the busy state, command and address register block 2300 latches the address received through input/output circuit 2500, but does not transmit the latched address to row selector 2200. Rather, the latched address is sent from command and address register block 2300 to row selector 2200 when or after the read/busy signal changes from the busy state to the ready state. That is, command and address register block 2300 receives and latches the address regardless of the state of the flash memory device, but outputs the latched address to row selector 2200 based on the read/busy control signal.

In a similar manner, where the read/busy control signal indicates that the flash memory device is in the ready state, command and address register block 2300 latches the command received through input/output circuit 2500 and transmits the command to program/read/erase control unit 2600. On the other hand, where the read/busy control signal indicates that the flash memory device is in the busy state, command and address register block 2300 latches the command inputted through input/output circuit 2500, but does not transmit the latched command to program/read/erase control unit 2600. Rather, the latched command is sent from command and address register block 2300 to program/read/erase control unit 2600 when or after the indication of the read/busy signal changes from the busy state to the ready state. That is, command and address register block 2300 receives and latches an issued command regardless of the state of the flash memory device but outputs the latched command to program/read/erase control unit 2600 based on the read busy control signal.

Ready/busy control unit 2400 generates the read/busy control signal under the control of program/read/erase control unit 2600, which indicates a busy state or a ready state of the flash memory device. The read/busy control signal is sent to controller 1000 of FIG. 1 through input/output circuit 2500 as read/busy signal R/nB. The read/busy control signal is also provided to command and address register block 2300 and program/read/erase control unit 2600. Program/read/erase control unit 2600 receives the latched command from command and address register block 2300 where the read/busy control signal indicates the ready state, and controls the flash memory device to perform operations required in response to the received command, such as a program operation, a read operation, and an erase operation. Page buffer 2700 temporarily stores data to be written to or to be read from memory cell array 2100.

As indicated above, even where the flash memory device is in the busy state, a command and an address are transmitted from controller 1000 to input/output circuit 2500 within the flash memory device. The command and address are then latched into command and address register block 2300. Commands and addresses latched in command and address register block 2300 during the busy state are executed when or after the ready/busy control signal indicates that the flash memory device is in the ready state.

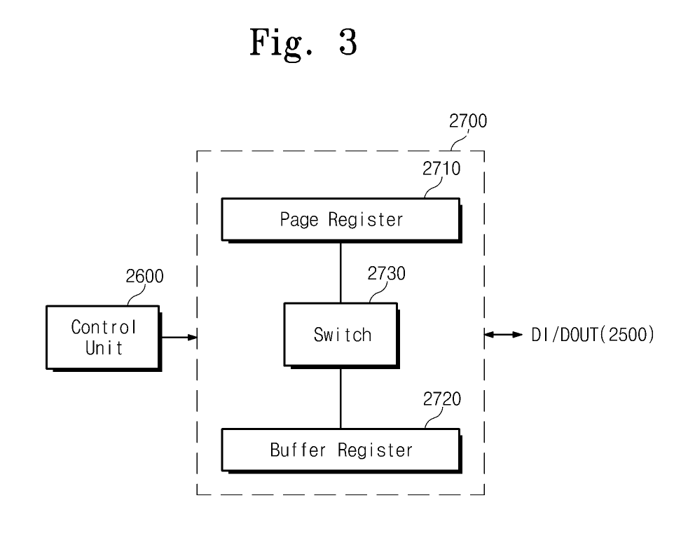

Further, even where flash memory device is in the busy state, data is input to the flash memory device from controller 1000 via input/output circuit 2500, and then loaded to page buffer 2700 in response to the ready/busy control signal. This process is described below with reference to FIG. 3.

FIG. 3 is a block diagram of page buffer 2700 illustrated in FIG. 2 according to an embodiment of the inventive concept. Referring to FIG. 3, page buffer 2700 comprises a page register 2710, a buffer register 2720, and a switch 2730. Page buffer 2700 operates as a sense-amplifier or a write driver circuit based on its operating mode under the control of program/read/erase control unit 2600. Data to be programmed to memory cell array 2100 is loaded to page register 2710, either directly or through switch 2730. Switch 2730 transfers data provided from input/output circuit 2500 to buffer register 2720 under the control of program/read/erase control unit 2600. Switch 2730 also transfers data stored at buffer register 2720 to page register 2710 under the control of program/read/erase control unit 2600. Switch 2730 transfers data provided from input/output circuit 2500 to page register 2710 under the control of program/read/erase control unit 2600.

Where the flash memory device is in the ready state, data provided from input/output circuit 2500 is transferred to the page register directly or through switch 2730 under the control of program/read/erase control unit 2600. On the other hand, where the flash memory device is in the busy state, data provided from input/output circuit 2500 is transferred to buffer register 2720 through switch 2730 under the control of program/read/erase control unit 2600. Thus, if the ready/busy control signal indicates the busy state, program/read/erase control unit 2600 can identify an input from input/output circuit 2500 as data in response to the combination of the control signals. If the input is identified as data, and the flash memory device is in the busy state, data received from input/output circuit 2500 is sent to buffer register 2720 via switch 2730 under the control of program/read/erase control unit 2600. Data stored at buffer register 2720 is sent to page register 2710 through switch 2730 after the busy state of flash memory device ends.

In one embodiment, while page register 2710 is being used for a current operation, such as an erase verification operation, a program operation, or a read operation, buffer register 2720 is used to temporarily store data for a next operation to be executed. On the other hand, data for the next operation is stored in buffer register 2720 or page register 2710 while page register 2710 is being used for the current operation.

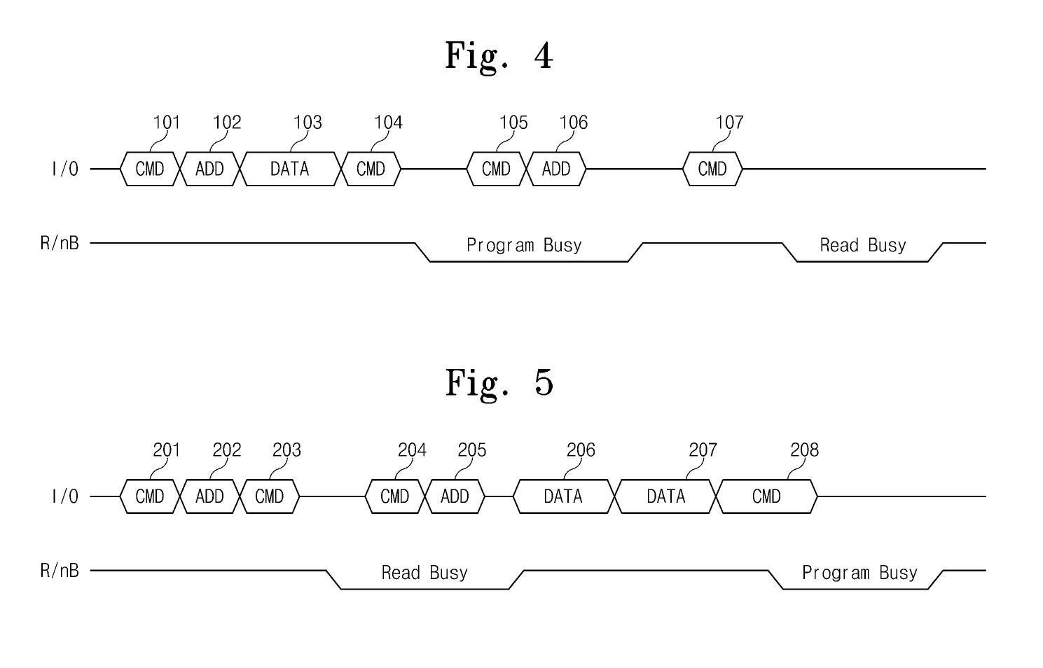

FIG. 4 is a timing diagram illustrating a first operation of the data storage system in accordance with an embodiment of the inventive concept. The first operation of the data storage system is explained below with reference to FIG. 1 through FIG. 4.

To program data in the flash memory device in storage device 2000, the host sends data to controller 1000. Buffer RAM 1400 of controller 1000 temporarily stores the transferred data. Thereafter, controller 1000 sends a serial data input command 101, an address 102, and transferred data 103 to the flash memory device through channel CH using a predetermined timing sequence. Command and address register block 2300 latches the inputted command 101 and address 102. Data 103 is loaded to page buffer 2700 through input/output circuit 2500 and switch 2730. Once controller 1000 sends a programming command 104 to the flash memory device, the flash memory device begins the programming operation under the control of program/read/erase control unit 2600. Then, program/read/erase control unit 2600 of the flash memory device controls ready/busy control unit 2400 to generate the ready/busy control signal with a level indicative of the busy state (labeled “Program Busy” in FIG. 4), which is sent to controller 1000 as ready/busy signal R/nB.

Once the flash memory device assumes the busy state, controller 1000 sends a first read command 105 and an address 106 for a next operation to the flash memory device. First read command 105 and address 106 are received via input/output circuit 2500 and latched by command and address register block 2300 in response to the ready/busy control signal in the busy state. While the ready/busy control signal indicates the busy state, command and address register block 2300 does not send the latched command 105 and address 106 to program/read/erase control unit 2600 and row selector 2200.

Once the programming operation ends, the ready/busy control signal changes to a level indicative of the ready state under the control of program/read/erase control unit 2600. Once the ready/busy control signal changes to the ready state, latched command 105 and address 106 in command and address register block 2300 are sent to both program/read/erase control unit 2600 and row selector 2200. Thereafter, the read/busy control signal transitions to the level indicative of the busy state (labeled “Read Busy” in FIG. 4) while a first read operation is performed in response to command 105 and address 106 and under the control of program/read/erase control unit 2600.

Controller 1000 transmits a second read command 107 to the flash memory device after first read command 105 and address 106. However, a second read operation is not performed in response to second read command 107 until after the first read operation is completed. Rather, upon initiation of the first read operation, program/read/erase control unit 2600 controls ready/busy control unit 2400 to generate the ready/busy control signal with the level indicative of the busy state, which is sent to the controller 1000 as ready/busy signal R/nB. Second read command 107 is latched in command and address register block 2300 while the first read operation is performed.

While the operation of only one flash memory device is explained above with reference to FIG. 4, other nonvolatile memory devices connected to channel CH may function similar to the device described above. Moreover, the other nonvolatile memory devices may operate in parallel with the described device to perform similar operations at the same time as the described device. In particular, these devices, while in the busy state, may receive commands and addresses for next operations from controller 1000. These operations may improve the performance of the data storage system and provide greater freedom for controller 1000. The additional freedom of controller 1000 allows it to perform various functions while the nonvolatile memory devices are busy, such as various FTL functions comprising garbage collection, merge operations, update operations of map data, backup operations for storing map data into storage device 2000, and external requests that do not require accessing storage device 2000.

In FIG. 4, second read command 107 is input to the command and address register block 2300 after the busy state of the programming operation ends. But second read command 107 may alternatively be provided to the flash memory device during the busy state of the programming operation. Also, in FIG. 4, during the busy state of the first read operation, additional commands, addresses, and data are not input from controller 1000. However, it is possible for such additional information to be input by controller 1000 during the busy state of the first read operation. As one example, an address for the second read operation could be input during the busy state of the first read operation.

FIG. 5 is a timing diagram showing a second operation of the data storage system in accordance with an embodiment of the inventive concept. The second operation of the data storage system is described below with reference to FIGS. 1, 2, 3, and 5.

In a read operation of storage device 2000, controller 1000 sends a first read command 201, an address 202, and a second read command 203 through channel CH in accordance with a predetermined timing sequence. Command and address register block 2300 latches address 202 and first and second read commands 201 and 203. The flash memory device begins the read operation after it receives second read command 203 from controller 1000. At this time, program/read/erase control unit 2600 of the flash memory device controls ready/busy control unit 2400 to generate the ready/busy control signal with the busy state (labeled “Read Busy” in FIG. 5), which is sent to controller 1000 as ready/busy signal R/nB.

While the flash memory device is in the busy state, controller 1000 sends a command 204 and an address 205 for the next operation to be executed, which is a program operation in the example of FIG. 5. Command and address register block 2300 latches command 204 and address 205 provided from input/output circuit 2500 in response to the ready/busy control signal of the busy state. While the ready/busy control signal indicates the busy state, command and address register block 2300 does not send latched command 204 and address 205 to program/read/erase control unit 2600 and row selector 2200. Then, once the read operation ends, the ready/busy control signal indicates the ready state under the control of program/read/erase control unit 2600. Once the ready/busy control signal changes to indicate the ready state, latched command 204 and latched address 205 in command and address register block 2300 are sent to both program/read/erase control unit 2600 and row selector 2200.

Read data 206 read from memory cell array 2100 of the flash memory device during the read operation is sent to controller 1000 through page buffer 2700 and input/output circuit 2500. Thereafter, controller 1000 sends data 207 to be programmed to the flash memory device. Data 207 is loaded to page buffer 2700. Then, after receiving a program command 208, the flash memory device begins the program operation under the control of program/read/erase control unit 2600. At this time, program/read/erase control unit 2600 controls ready/busy control unit 2400 to generate the ready/busy control signal of the busy state like the program state, which is sent to controller 1000 as ready/busy signal R/nB.

In the example of FIG. 5, commands, addresses, and data are not input from controller 1000 during the busy state of the programming operation (labeled “Program Busy” in FIG. 5). But it should be understood that a command, address, and data for the next operation after the programming operation may be input to the flash memory device from controller 1000 during the busy state of the programming operation.

As indicated by the above description, sending commands and addresses for next operations to flash memories from controller 1000 while the flash memories are in the read busy state may improve both the operating speed of the data storage system and the freedom of controller 1000. As the freedom of controller 1000 increases, the performance of the data storage system is improved. For instance, controller 1000 may be able to perform other operations while the flash memories are busy, such as various FTL functions comprising garbage collection, merge operations, updating operation of map data, backup operation storing map data into the storage device, etc., and external requests that do not require accessing the storage device.

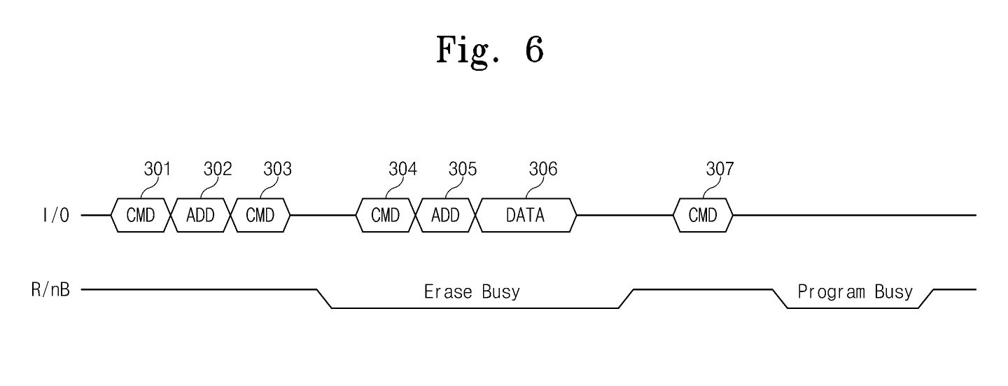

FIG. 6 is a timing diagram illustrating a third operation of the data storage system in accordance with an embodiment of the inventive concept. The operation of this embodiment is described below with reference to FIGS. 1, 2, 3, and 6.

In an erase operation of storage device 2000, controller 1000 sends a block erase set-up command 301, an address 302, and an erase command 303 through channel CH with a predetermined timing sequence. Command and address register block 2300 latches commands 301 and 303 along with address 302. The flash memory device begins the erase operation after receiving erase command 303 from controller 1000. Then, program/read/erase control unit 2600 of the flash memory device controls ready/busy control unit 2400 to generate the ready/busy control signal with a level indicating the busy state (labeled “Erase Busy” in FIG. 6), which is sent to controller 1000 as ready/busy signal R/nB.

Once the flash memory device stays in the busy state, controller 1000 sends a command 304, an address 305, and data 306 for the next operation to be executed (a program operation), to input/output circuit 2500 within the flash memory device. Thereafter, command and address register block 2300 latches command 304 and address 305 in response to the ready/busy control signal of the busy state. While the ready/busy control signal indicates the busy state, command and address register block 2300 does not send latched command 304 and latched address 305 to program/read/erase control unit 2600 and row selector 2200. Data 306 is loaded to buffer register 2720 via switch 2730 under the control of program/read/erase control unit 2600 while the ready/busy control signal indicates the busy state. If the erase operation does not require a verification of the erase operation, the data input during the busy state is loaded to page register 2710 through switch 2730 under the control of program/read/erase control unit 2600.

Once the erase operation is completed, the ready/busy control signal indicates a ready state under the control of program/read/erase control unit 2600. Then, with the ready/busy control signal indicating the ready state, latched command 304 and latched address 305 in command and address register block 2300 are sent to both program/read/erase control unit 2600 and row selector 2200. Then the host sends a program command 307 to the flash memory device in response to the ready/busy control signal of the ready state. If the flash memory device receives program command 307, the flash memory device begins to start the program operation. Then, program/read/erase control unit 2600 of the flash memory device controls ready/busy control unit 2400 to generate the ready/busy control signal with the level indicating the busy state (labeled “Program Busy” in FIG. 6), which is sent to controller 1000 as ready/busy signal R/nB.

In FIG. 6, a command, address, and data are not input from the host during the program busy state. But a command, address, and data for the next operation of the flash memory device are input during the program busy state.

As discussed above, even where flash memory devices are in the erase busy state, by sending a command and an address for the next operation to flash memories from controller 1000, the operating speed of the data storage system is improved and the freedom of controller 1000 also increases. As the freedom of controller 1000 increases, the performance of the data storage system improves. For instance, by transmitting information to storage device 2000 even where the flash memory devices are busy, controller 1000 may avoid idle time, instead performing operations such as various FTL functions comprising garbage collection, merge operation, updating operation of map data, backup operation storing map data into the storage device, etc., and external requests that do not require accessing the storage device.

In the timing diagrams in FIG. 4 through FIG. 6, a part or all of addresses, commands, and data for a next operation during a busy state of the flash memory device are received to the flash memory device from the controller. Information that can be input to the flash memory device from the controller is not limited to these examples as shown in FIG. 4 through FIG. 6.

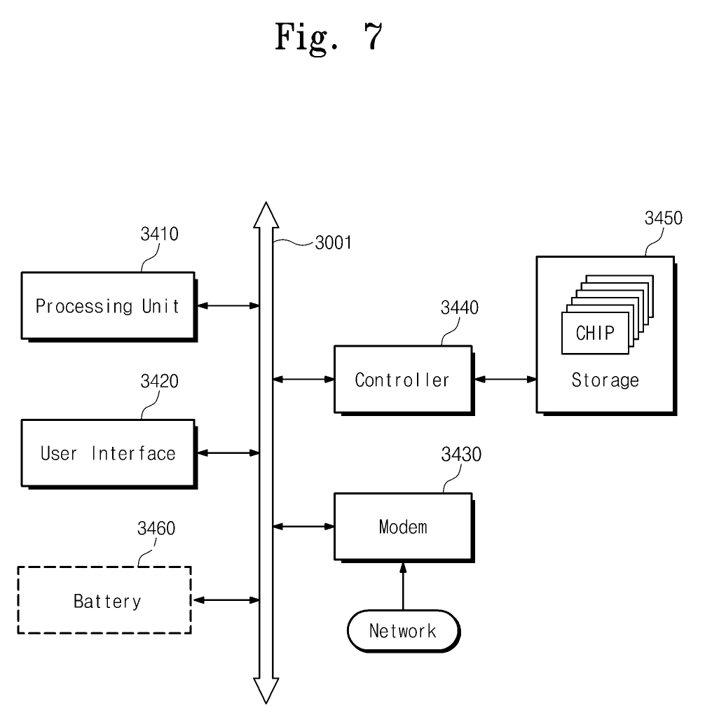

FIG. 7 illustrates a computing system comprising the data storage system illustrated in FIG. 1 according to an embodiment of the inventive concept. Referring to FIG. 7, the computing system comprises a processing unit 3410, a user interface 3420, a modem 3430, and a controller 3440, all connected to system bus 3001. The computing system further comprises a data storage system 3450 connected to controller 3440. Controller 3440 and data storage system 3450 have substantially the same construction as controller 1000 and storage device 2000 of FIG. 1. In the embodiment of FIG. 7, data storage system 3450 stores N-bit data that has been processed or is to be processed by processing unit 3410. In some embodiments, such those where the computing system is a portable device, a battery 3460 may be included to supply power. Additionally, though not shown in FIG. 7, the computing system may further comprise an application chipset, a camera image processor CIS, a mobile DRAM, or the like.

As indicated by the foregoing, a data storage system according to selected embodiments of the inventive concept may improve performance of a computing system by performing background operations while a nonvolatile memory device is in a busy state.

Data storage system 3450 and/or controller 3440 may be mounted in various types of packages, such as, package on package (PoP), ball grid array (BGA), chip scale package (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat package (TQFP), small outline IC (SOIC), shrink small outline package (SSOP), thin small outline package (TSOP), thin quad flat package (TQFP), system in package (SIP), multi-chip package (MCP), wafer-level fabricated package (WFP), wafer-level processed stack package (WSP).

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A data storage system, comprising:
a storage device comprising a plurality of nonvolatile memories each capable of assuming a busy state and a ready state; and
a controller interfacing with the storage device via a channel and configured to transmit a part or all of a command, address and data for an operation to a selected nonvolatile memory in the storage device while the selected nonvolatile memory is in the busy state;
wherein the storage device stores the transmitted part or all of the command, address and data and the controller performs a background operation while the selected nonvolatile memory remains in the busy state.

2. The data storage system of claim 1, wherein the command is one of a program command, an erase command, and a read command.

3. The data storage system of claim 1, wherein the background operation comprises one of garbage collection, a merge operation, and a map data update or backup operation.

4. The data storage system of claim 1, wherein each of the nonvolatile memories is configured to latch the part or all of the command, the address and data transmitted from the controller.

5. The data storage system of claim 4, wherein each of the nonvolatile memories comprises:
a ready/busy control unit configured to generate a ready/busy control signal;
a command and address register block configured to latch an address and a command received from the controller and to operate in response to the ready/busy control signal; and
a program/read/erase control unit configured to control an operation based on the command and address latched in the command and address register block in response to the ready/busy control signal.

6. The data storage system of claim 5, wherein the command and address register block is configured to latch a command and an address received from the controller during a ready state or a busy state of the ready/busy control signal; and
wherein the address and command received from the controller during the busy state are respectively sent to a row decoder and the program/read/erase control unit after the ready/busy control signal changes to the ready state.

7. The data storage system of claim 5, wherein each of the nonvolatile memories further comprises a page buffer block that operates under control of the program/read/erase control unit and is configured to read data from a memory cell array and to program data to the memory cell array.

8. The data storage system of claim 7, wherein the page buffer block comprises:
a switch configured to operate under control of the program/read/erase control unit;
a page register configured to store data received through the switch during a ready state of a corresponding nonvolatile memory; and
a buffer register configured to store data received through the switch during a busy state of the corresponding nonvolatile memory.

9. The data storage system of claim 8, wherein where the corresponding nonvolatile memory is set to the busy state, the program/read/erase control unit controls the switch to send data stored in the buffer register to the page register.

10. The data storage system of claim 1, wherein the data storage system is one of a solid state disk and a memory card.

11. The data storage system of claim 1, wherein the busy state is one of a programming busy state, a read busy state and an erase busy state.

12. The data storage system of claim 1, wherein at least one of the nonvolatile memories comprises a flash memory.
